(19) United States
(12) Patent Application Publication
(10) Pub. No.: US 2003/0149613 A1
(43) Pub. Date: Aug. 7, 2003

(54) Computer-implemented system and method for performance assessment

(76) Inventors: Marc-David Cohen, Hillsborough, NC (US); Andres Leonardo Medaglia, Durham, NC (US)

Correspondence Address: STEPHEN D. SCANLON, JONES DAY, 901 LAKESIDE AVENUE, CLEVELAND, OH, 44114, US

(21) Appl. No.: 10/062,688

(22) Filed: Jan. 31, 2002

(51) Int. Cl. G06F 17/60

(52) U.S. Cl. 705/11

(57) ABSTRACT

A computer-implemented method and system for assessing performance-related data for a preselected set of performers. Performance measures data are received for performers as well as business logic rules that are related to at least one of the performance measures. A mathematical optimization program is constructed to include an overall performance rating as an objective function. The mathematical optimization program is used to optimize the overall performance rating of the performers by adjusting a set of weights constrained by the business logic rules. The overall performance rating is used to assess the performance of the performers.

### BACKGROUND OF THE INVENTION

1. Technical Field

The present invention is generally directed to computer-implemented data analysis systems. More specifically, the present invention is directed to performance assessment computer-implemented data analysis systems.

2. Description of the Related Art

In many businesses, data on supplier performance are collected and used to compare similar suppliers. The suppliers are then graded and compared against the rest of the field based on user-supplied criteria. Frequently, grading and comparing these suppliers based on these data are not straightforward because some criteria may conflict with other criteria. For example, if one supplier outperforms the others under one criterion, but fails to achieve satisfactory levels on other criteria, it becomes unclear on how to proceed with the comparison.

The traditional solution to this problem is to assign fixed weights to each criterion and form an aggregated, weighted score. Generally, weights are chosen to account for the specific business rules that are the drivers in this process. For example, bigger weights may be given to measures of quality than to measures of financial attributes because they may be more important. The suppliers are then ranked using their aggregated, weighted scores. Even though this process is appealing, there are several problems associated with it. For example, different measurement units are used for different performance criteria. This affects the influence of the weights used in the scoring. Weights are subjective, difficult to agree upon, and have a significant effect on the final scoring. Also, it is difficult to balance the value of relatively strong and weak performances in multiple criteria. These business problems thus attempt to rate suppliers on the basis of multiple and conflicting performance measures and further use subjective, underdetermined business rules to select the supplier with the best rating.

### SUMMARY OF THE INVENTION

The present invention overcomes the aforementioned disadvantages as well as others of the traditional solutions. In accordance with the teachings of the present invention, a computer-implemented method and system are provided for assessing performance-related data for a preselected set of performers. Performance measures data are received for a performer as well as business logic rules that are related to at least one of the performance measures. A set of mathematical optimization programs are constructed to include an overall performance rating as an objective function. The models are used to optimize the overall performance rating of performers by adjusting a set of weights constrained by the business logic rules. The overall performance rating is used to assess the performance of the performers.

### BRIEF DESCRIPTION OF THE DRAWINGS

FIG. 1 is a block diagram depicting a performance analysis system;

FIG. 2 is a block diagram depicting an exemplary mathematical optimization technique for use in analyzing performance measures;

FIGS. 3A and 3B are flowcharts depicting the system-level steps used to analyze performance measures;

FIGS. 4A and 4B are flowcharts depicting steps used to capture the business logic for analyzing performance measures;

FIGS. 5A and 5B are flowcharts depicting the supplier-performance normalization process;

FIGS. 6A and 6B are flowcharts depicting the optimization steps to analyze performance measures; and

FIGS. 7-9 are bar graphs depicting exemplary results using the performance analysis system.

### DETAILED DESCRIPTION OF THE DRAWINGS

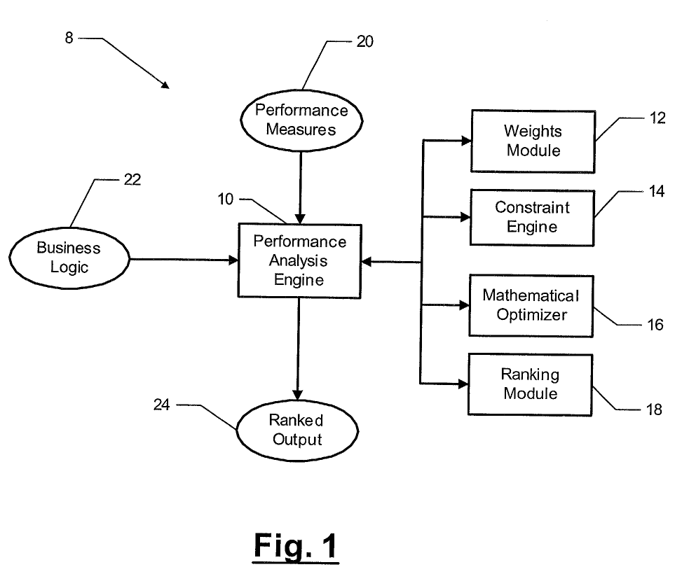

FIG. 1 depicts a computer-implemented system 8 that assesses performances of one or more companies, individuals, products, services or other entities. The assessment is based upon performance measures data 20 as well as user-specified business logic 22 that controls the relative influence of the performance measures. The system 8 evaluates each entity under its best possible light within the restrictions presented by the business logic. An overall weighted performance index is calculated for each entity and is provided to the user as a ranked output 24.

As an example, the system 8 may use performance measures data 20 to evaluate the performance of different suppliers. In this example, the performance measures data may include the cost, quality, time for delivery, and dependency for each supplier. A first supplier may deliver a good for $0.80/unit, a quality rating of 0.95, an average time for delivery of 7 days, while historically accepting and filling 97% of all orders placed. A second supplier may deliver the good for $0.75/unit, a quality rating of 0.99, an average time for delivery of 10 days, while historically accepting and filling 85% of all orders placed. The performance measures data 20 for the first supplier would be: [0.8, 0.95, 7, 0.97], and the performance measures data for the second supplier would be: [0.75, 0.99, 10, 0.85]. The first supplier has a better delivery time, and can generally fill more orders than the second supplier, but the first supplier is more expensive and provides a good of lower quality. The problem of determining who is the better supplier may be intractable for traditional solutions given the ability of each of the suppliers to outperform the other supplier in at least one performance measure.

The system 8 incorporates the business logic input data 22 with the performance measures data 20 to determine which supplier better meets the needs of the user. The business logic input data 22 constitute an optional set of parameters that controls the relative influence of each performance measure, and that may further control the desired relationships among the different performance measures data 20.

The system 8 uses a performance analysis engine 10 to process the performance measures data 20 and the business logic input data 22 for generating the ranked output 24. The performance analysis engine 10 includes a weights module 12 to compute and store weights derived from the business logic input data 22. The weights module 12 may also normalize the performance measures data 20 so that performance measures have similar ranges. The normalization process transforms a performance measure so that the same types of performance measure (i.e., cost or time for delivery) for the suppliers have a similar value range, such as between zero and one. For example, a performance measure which has a range ten orders of magnitude different than other performance measures may be transformed into a range having the same range as the other performance measures.

The normalization process transforms the performance measures into a similar range with unitless measures. The performance analysis engine 10 then compares different performance measures which would otherwise have different units. The weights module 12 thus normalizes the ranges of the performance values so that the performance analysis engine 10 optimizes the suppliers' performance based on the weights and constraints generated from the business logic input data 22.

The performance analysis engine 10 also includes a constraint engine 14 to interpret the user input 22 and determine a set of mathematical formulae that relate different performance measures. The formulae relate different performance measures, either in relative terms or absolute terms. The constraint engine 14 also determines the optimization process for the parameters and the direction of the optimization. Once the constraint engine 14 has constructed all relevant relational formulae, then the performance analysis engine 10 triggers a mathematical optimizer program 16 to optimize the supplier's performance based on the constraints. This optimization process is repeated for each supplier under comparison.

The optimizer 16 optimizes each supplier's performance rating independent of other suppliers' performance data. The optimizer 16 retrieves performance data from a single supplier, and optimizes the performance rating for that supplier using the constraints generated by the constraint engine 14. After the optimizer 16 calculates an optimal set of weights and a total weighted performance index for each supplier, the performance engine 10 sends the performance scores for all the suppliers to ranking module 18.

The ranking module 18 ranks the suppliers according to the optimal scores obtained by the optimizer 16. The ranking module 18 may also rank the suppliers by clustering or quartiles based on the optimal scores, depending on the needs of the user. The results of the ranking module 18 are output to the performance analysis engine 10 which displays the ranked output 24 for the user.

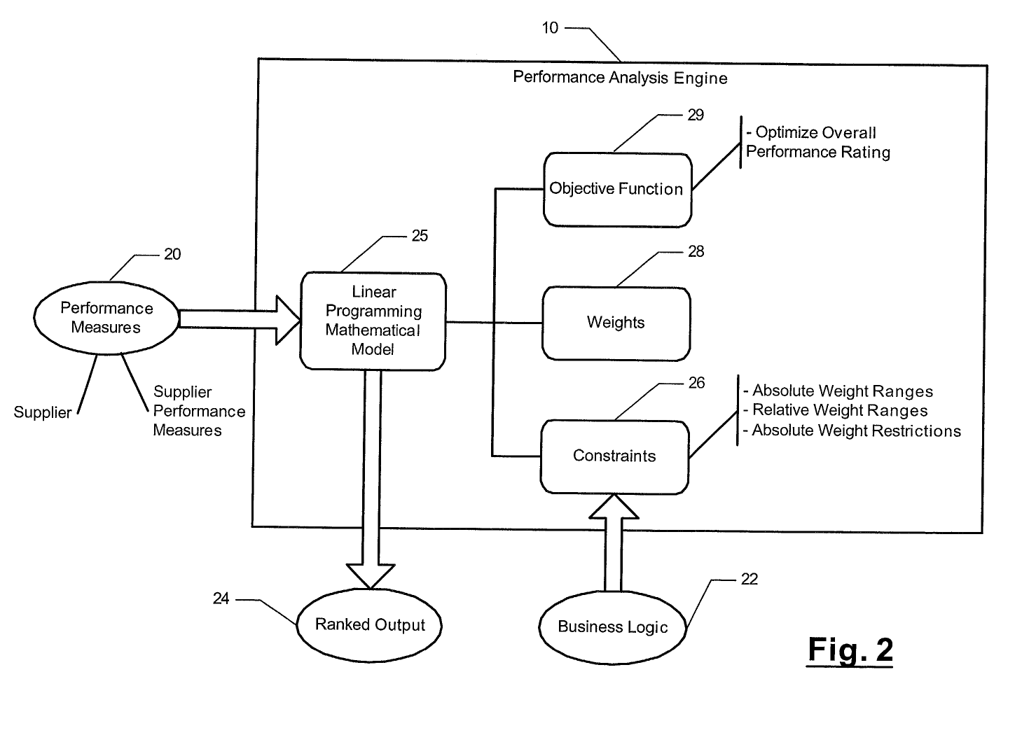

Different mathematical optimization programming techniques may be used for optimizer 16. FIG. 2 depicts one such exemplary technique that uses a linear programming (LP) mathematical model 25 to analyze the business logic input data 22 and the performance measures data 20. The LP model 25 includes a set of constraints 26, weights 28, and an objective function 29. The constraints 26 establish permissible limits on the weights 28 as the objective function 29 adjusts the weights 28 while it seeks optimality for a supplier's performance measures data 20.

The constraints 26 are based upon the business logic input data 22 and may take many forms. For example, the constraints 26 may take the form of a user specifying ranges for the parameter of a performance measure 20, or a user may enter a relative parameter such that the value of the parameter for one performance measure depends on the value of the parameters for one or more performance measures 20. The user may relate some of the performance measures 20, or group the performance measures 20 into similar, functional performance measure types, which may then be equally weighted in the optimization. For instance, in the supplier evaluation example, the providers may be assessed such that the cost and quality measures should account for at most 50% of the score, while constructing a ranking that treats delivery time as a more important measure than the filling rate.

The business logic input data 22 weights the different performance measures 20 for the suppliers so that each supplier may be ranked according to a weighted total based on all the performance measures 20 of a supplier. These ranges and restrictions generate flexible control within the system and can be used as a more general business rule set than may otherwise be obtained using fixed weights for the business logic within the system.

The LP optimization process is driven by the objective function 29. The objective function 29 is modeled by the maximal score that a given unit under comparison can achieve. Thus, if a user wants to find the best supplier given the ranges for the weights 28 constrained by the business logic input data 22, then for each supplier, relational formulae are generated to achieve an optimization that maximizes each supplier's performance rating.

The LP optimizer 25 adjusts the weights 28 within the bounds set by the constraints 26, and seeks a higher score in each iteration. If the LP optimizer 25 determines that there is no possibility of incrementing the score of the supplier in the next iteration, the optimization process is halted and the optimal score for that supplier is achieved. Once an optimal set of weights 28 is determined by the LP optimizer 25, then the overall supplier performance measure is calculated and stored for that supplier. Other suppliers' input data are similarly optimized and result in an overall performance measure for each supplier. The weights, though, for each of the suppliers may be different than weights for other suppliers.

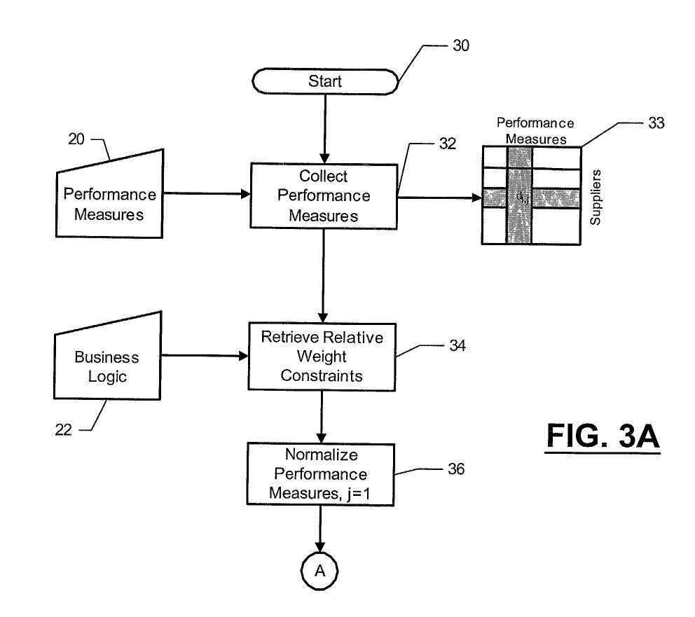

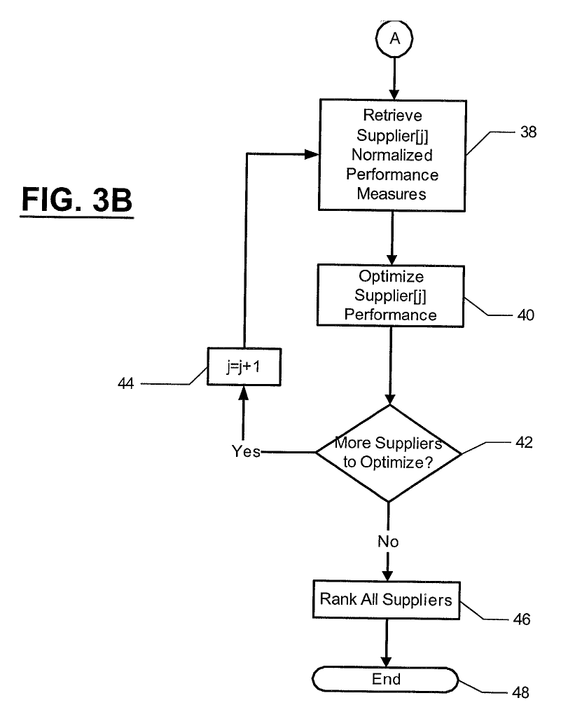

FIGS. 3A and 3B depict the system-level steps for analyzing performance data. The method begins in step 30. Performance measures are collected in step 32 from the performance measures data 20. The supplier performance measures data 20 collected in step 32 are processed into format 33 such that each supplier corresponds to a row and each column corresponds with a performance measure. For example, in a Supplier Relationship Management (SRM) system, suppliers may be commodity suppliers and performance measures may be scores such as Supplier Evaluation Risk (SER), Financial Stress Score (FSS), delivery quality, and product quality. In a global competitiveness example of the aviation industry, the suppliers may be companies that provide aviation equipment and the performance measures may be operating earnings and employee productivity. Step 32 thus retrieves this information about the suppliers and generates the matrix format for all suppliers across all performance measures.

The performance engine then collects the business logic input data 22 and retrieves the relative weight constraints in step 34. In step 36, the performance measures are normalized, and the constraints are gathered. The optimizer then retrieves the next supplier's performance measures in step 38 from the normalized measures generated in step 36. The optimizer then optimizes the supplier's performance in step 40 based upon the normalized performance measures for that supplier and the constraints. Decision block 42 determines if more suppliers are to be optimized. If more suppliers are to be optimized then the optimizer 16 retrieves the next supplier's performance measures in step 38. If all of the suppliers have been optimized, then step 46 ranks all suppliers based upon their optimized performance ratings. The method ends in step 48.

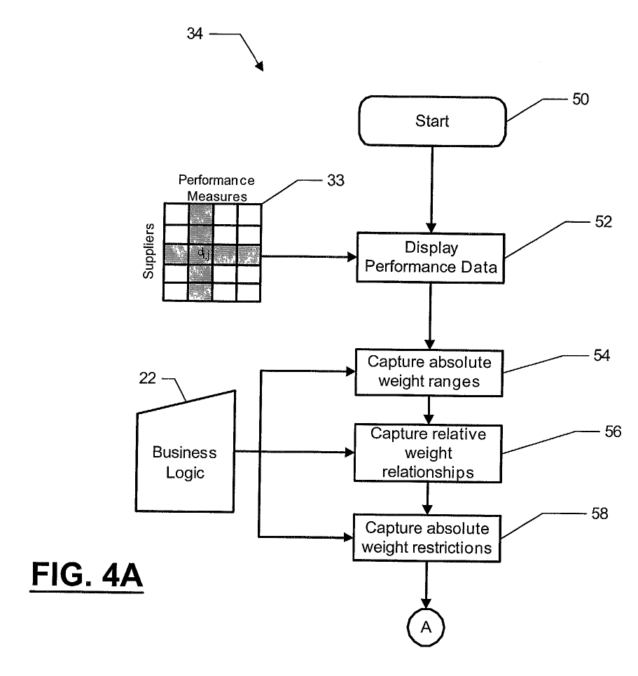

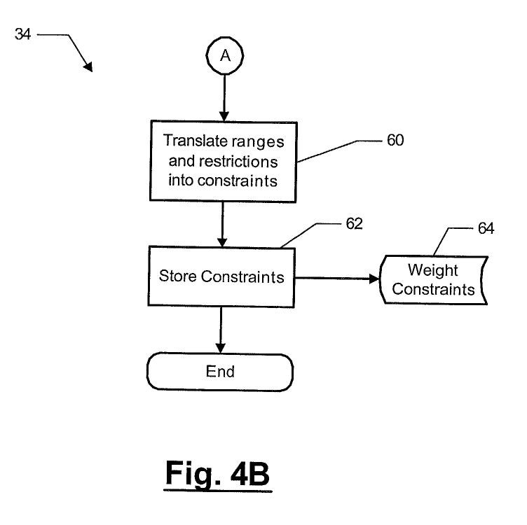

FIGS. 4A and 4B describe in greater detail the steps used to capture the business logic (i.e., step 34 of FIG. 3A) for use in ranking performances. By executing the steps, the system captures the business rules by placing restrictions on the ranges and relationships of the weights for the various performance criteria.

The method starts in step 50. Step 52 displays the performance measures data 20 to assist the user in capturing business logic. Steps 54, 56, and 58 capture the weight ranges, relationships, and restrictions from the user input 22. The information captured are for absolute weight ranges in step 54, relative weight relationships in step 56, and absolute weight restrictions in step 58. This business logic may be captured in any order, and all of these different types of logic may not be captured during the weight restriction capture steps, if the user determines not to use one or more of these types of restrictions.

The weight restriction capture steps 54, 56, and 58 recognize that performance measures may not be equally important and known precisely. To account for these kinds of variations, the calculation of weights can be restricted to a user-supplied range of weights, expressed in percentage. For instance, in the aforementioned aviation industry example, the weight given by the experts to the operating earnings may be higher than the one given to the employee productivity. This relative importance can be captured by requiring that operating earnings must account for at least 20% and at most for 25% of any aggregated score that is calculated.

Also, the weight restriction capture steps 54, 56, and 58 recognize that it may be relevant in that one performance measure (or group of measures) should be given a greater importance than another measure (or group of measures). Additional relative constraints may be added during the weight restriction capture steps 54, 56, and 58 to represent this restriction. For example, suppose that there are financial and quality measures of performance among the comparing criteria, but from an institutional perspective the quality measures of the suppliers are more important than the financial measures. Adding a constraint that requires that the sum of the weights for the financial measures should not exceed the sum of the weights for the quality measures can capture this business logic constraint. Moreover, this could be extended so that the sum of the weights for the quality measures should exceed the sum of the weights for the financial measures by a constant percentage, such as 10%.

The weight restriction capture steps 54, 56, and 58 also may generate absolute restrictions on some of the weights. For example, it would then be possible to require that the sum of weights of all financial measures account for a fixed amount of the total. The weight restriction capture steps 54, 56, and 58 thus allow the user to use a hierarchical structure in determining weights. The user may build ranges and restrictions for certain types of data, for example quality or financial data, or may specifically target individual performance measures for specific weights ranges or restrictions.

After the weights are restricted by the user, the method converts the business logic into constraints in step 60. Step 60 resolves the logic into algebraic formulae so that the optimizer 16 may solve for the weights through the proper manipulation of the constraints 64 that are stored by step 62.

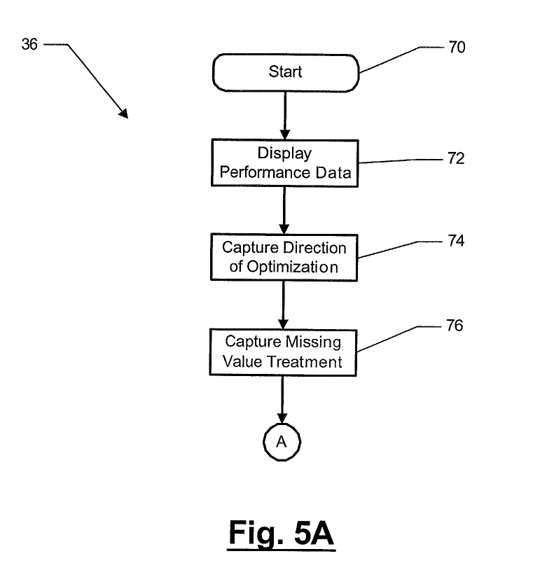

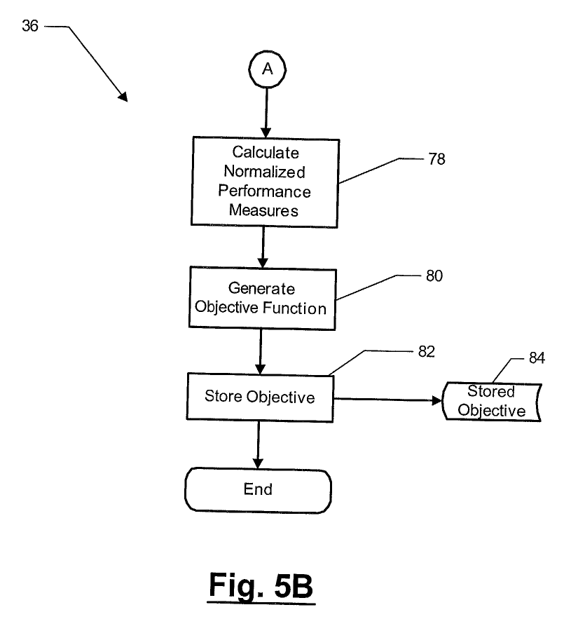

FIGS. 5A and 5B depict in greater detail the supplier-performance normalization and objective function generation process 36. The normalization corrects for performance measurements measured in different units and provides greater numerical stability to the LP optimizer 16. The system normalizes and maps the performance measures to values between zero and one. This resolves the possible problem of some performance measures dominating others just because of the magnitude of the scale of the different performance measures. Normalizing the data also generates dimensionless performance measures so that it is possible to add otherwise dissimilar performance measures to form a final score.

The method begins in step 70. The performance measures data is first displayed to the user in step 72. Step 74 captures the direction of the optimization. In step 76, the method captures the treatment of missing values from the performance measure data. For each performance measure, missing values in the performance measure data can be replaced, for example, by the average, smallest, largest, or a user-supplied value. By capturing missing values in step 76, the method allows for a comparison of all suppliers with the same data, although some of these data may initially have been missing from the performance measure data.

Once all values are determined in the performance measure data, then step 78 normalizes each performance measure according to the range of that performance measure. The performance measures may be normalized in step 78 using the following equations:

In the case of supplier performance maximization,

$${g}_{ij} = \{ \begin{matrix}\frac{{d}_{ij} - {min}_{j} \{ {d}_{ij} \}}{{max}_{j} \{ {d}_{ij} - {min}_{j} \{ {d}_{ij} ) \}} , & if {max}_{j} \{ {d}_{ij} - {min}_{j} \{ {d}_{ij} \} \} \neq 0 \\ 0 , & otherwise\end{matrix}$$

whereas in the case of supplier performance minimization,

$${g}_{ij} = \{ \begin{matrix}\frac{- {d}_{ij} - {min}_{j} \{ - {d}_{ij} \}}{{max}_{j} \{ - {d}_{ij} - {min}_{j} \{ - {d}_{ij} ) \}} , & if {max}_{j} \{ - {d}_{ij} - {min}_{j} \{ - {d}_{ij} \} \} \neq 0 \\ 0 , & otherwise\end{matrix}$$

where, dᵢⱼ and gᵢⱼ are the values of the original and normalized performance measure i for supplier j, respectively. The direction of the optimization, either a maximization or a minimization, is determined in step 74. The normalized supplier performance data is saved and an objective function is then generated in step 80. The objective function for a supplier is generated by taking the performance measures for that supplier, and generating an equation based on the weights and the values of the performance measures. For example, a performance matrix containing twenty suppliers (i.e., j=1, . . . , 20) and three performance measures (i.e., i=1, 2, 3) for each supplier would yield the following objective function for supplier j: overall weighted performance index=w₁×g₁ⱼ+w₂×g₂ⱼ+w₃×g₃ⱼ. Thus, there would be twenty objective functions, one for each supplier, where the gᵢⱼ values are taken from the normalized performance measures and the weights (wᵢ) are constrained by the constraints generated from the user-supplied business logic. The final step in this process is to store the business logic on the objective function in step 82 as the stored objective 84 for use in the optimization engine.

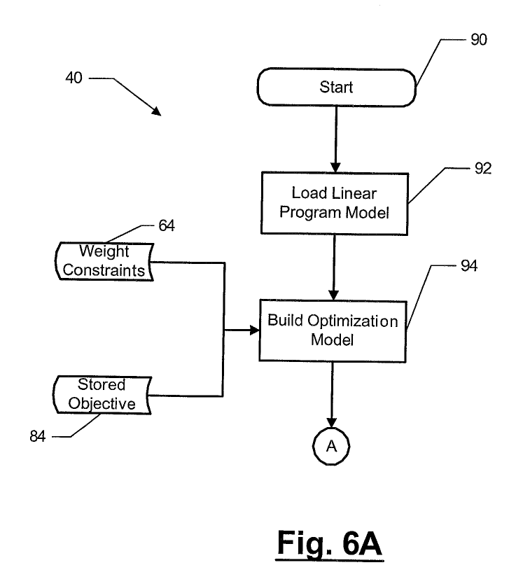

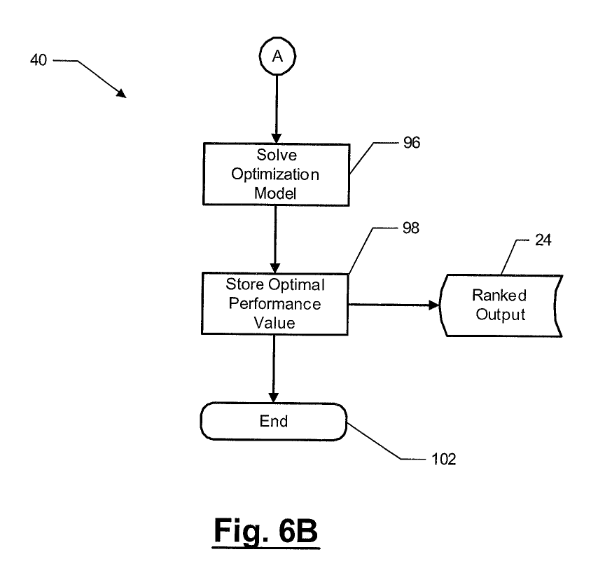

FIGS. 6A and 6B depict the optimization process 40. The method begins in step 90. The constructed optimization model is loaded in step 92. Step 94 builds the optimization model for the supplier from the loaded linear model and the weight constraints 64 and the stored objective 84.

The system evaluates in step 96 each supplier in isolation by solving for the best possible combination of weights that maximizes the score of an individual supplier. This may be accomplished by solving the linear program of the optimization model. Let I be the set of performance measures (criteria) and J the set of suppliers under comparison. Let gᵢⱼ be the normalized values of the performance measure (criterion) i for supplier j. Due to the performance normalization (see 78), the following is established: 0≦gᵢⱼ≦1, for all iεI and jεJ.

Let wᵢ be the weight for the performance measure (criterion) i. The wᵢ's are the quantities to be determined through the optimization process (decision variables). Let lᵢ and uᵢ be the lower and upper bounds for weight wᵢ, respectively, which are to be set in the optimization steps 92, 94, 96, and 98 (of FIGS. 6A and 6B).

Let A_{•}⊂I and B_{•}⊂I be the index sets of two categories of performance measures. Let

$${\sum }_{i ∈ {A}_{•}} {w}_{i} and {\sum }_{i ∈ {B}_{•}} {w}_{i}$$

be the compound weight for the category represented by index set A_{•} and B_{•}, respectively. Let T_{A}, T_{B}, T_{C}, and T_{D}, the total number of business rules of type A, B, C, and D, respectively (see steps 54, 56, and 58). Let f_{b} be the bounding factor for business rules of type B (for bε{1, . . . , T_{B}}). Let k_{c} be the absolute compound weight for business rules of type C (for cε{1, . . . , T_{C}}). Let \overline{l}_{d} and \overline{u}_{d}, be the absolute compound weight lower and upper bounds for business rules of type D (for dε{1, . . . , T_{D}}), respectively.

For a given unit j′εJ, the objective is to maximize its score zⱼ. This can be written as follows:

$$max {z}_{{j}^{′}} = {\sum }_{i ∈ I} {w}_{i} {g}_{{ij}^{′}} .$$

The following constraints establish that the weights fall into admissible values:

$${\sum }_{i ∈ I} {w}_{i} = 1$$

Convexity constraint.

lᵢ≦wᵢ≦uᵢ, [symbol] iεI

Lower and upper bounds.

wᵢ≧0, [symbol] iεI

Non-negativity

The additional business rules may be modeled by the following set of exemplary constraints:

| | |
|---|---|
| ${\sum }_{i ∈ {A}_{a}} {w}_{i} \geq {\sum }_{i ∈ {B}_{a}} {w}_{i} , for a ∈ \{ 1 , … , {T}_{A} \}$ | Business rules to model the relative importance between categories (type A) |
| $\begin{matrix}{\sum }_{i ∈ {A}_{a}} {w}_{i} \geq {\sum }_{i ∈ {B}_{a}} {w}_{i} \\ \frac{{\sum }_{i ∈ {A}_{b}} {w}_{i}}{{\sum }_{i ∈ {B}_{c}} {w}_{i}} \leq 1 + {f}_{b}\end{matrix} \} for b ∈ \{ 1 , … , {T}_{B} \}$ | Business rules to model the relative importance between categories with bound (type B) |
| ${\sum }_{i ∈ {B}_{c}} {w}_{i} = {k}_{c} , for c ∈ \{ 1 , … , {T}_{C} \}$ | Business rules to model the absolute importance of a category (type C) |
| ${\overline{l}}_{d} \leq {\sum }_{i ∈ {A}_{d}} {w}_{i} \leq {\overline{u}}_{d} , for d ∈ \{ 1 , … , {T}_{D} \}$ | Business rules to model the absolute importance of a category with bounds (type D) |

The solution of this linear program for each supplier is stored in step 98 and subsequently ranked according to the relative values of all suppliers. From the ranked output 24, a user may then choose a supplier with a high performance ranking based on the business needs of the user. The system processes each supplier in turn before terminating at step 102.

As an example, the performance analysis system may be used to determine the performance characteristics of suppliers of aviation equipment. The performance measures used in this performance example are Operating Earnings (OPR Earnings), Return on Net Assets (RONA), Working Capital Productivity (WCP), Independent Research and Development (IR&D), and Employee Productivity (PROD). Example performance measure weights have been given initial arbitrary weight measurements to these performances, which are shown in Table 1.

TABLE 1
Weights of the performance measures.

| Performance Measure | Weight |
|---|---|
| OPR Earnings | 8.91 |
| RONA | 8.85 |
| WCP | 8.44 |
| IR & D | 6.38 |
| PROD | 7.17 |

The information in Table 1 may be used as a starting point for constructing the relative importance of the performance measures shown in Table 2.

TABLE 2
Performance measure's relative importance.

Relative
Importance

| Performance | Lower | Upper |
|---|---|---|
| Measure | Limit | Limit |
| OPR Earnings | 20.0% | 25.0% |
| RONA | 20.0% | 25.0% |
| WCP | 20.0% | 25.0% |
| IR & D | 15.0% | 20.0% |
| PROD | 15.0% | 20.0% |

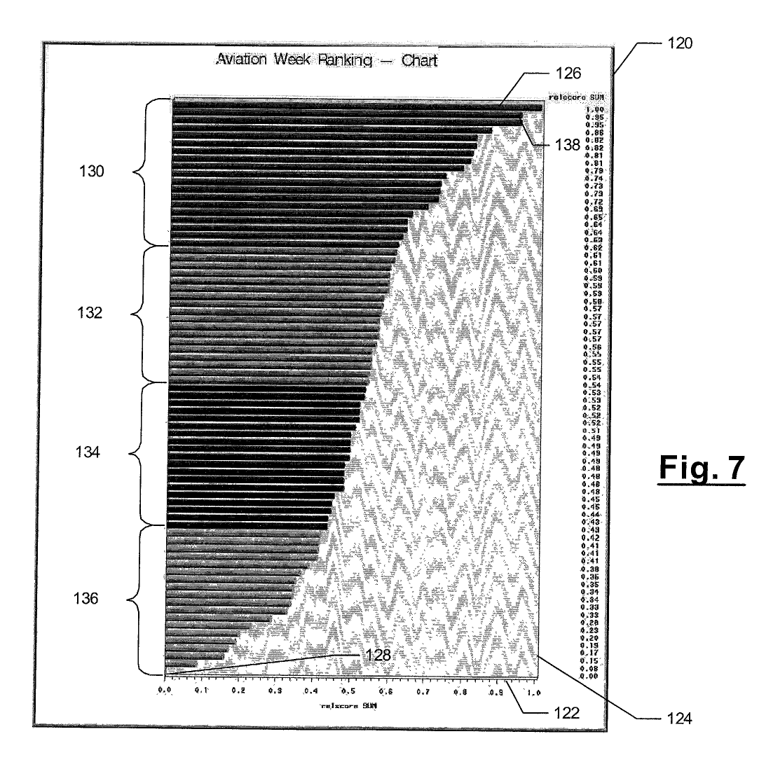

Table 2 shows that the performance measures OPR earnings, RONA, and WCP are each constrained with respect to their relative importance to be between 20.0% and 25%. The IR&D and PROD performance measures have been constrained to be between 15.0% and 20.0%. Once these relative weighting ranges are input, then the LP optimizer may optimize each suppliers performance value by adjusting the weights for each performance measure, according to the constraints input by the user (i.e., the weight ranges of Table 2). The results then can be generated without being restricted to the arbitrary weighting system of Table 1. The ranking module can graphically display the ranking of the suppliers as shown in FIG. 7.

FIG. 7 depicts bar graph 120 with axes 122 and 124. Axis 122 is the ranking score for each supplier in a range from zero to one. Axis 124 contains the suppliers sequentially ordered from the supplier with the highest relative score (i.e., highest performing supplier 126) to the supplier with the lowest relative score (i.e., lowest performing supplier 128). The overall performance rating scores for the suppliers are weighted as a percentage of the highest performing supplier, thus the highest performing supplier receives a relative score of 100%, and the other suppliers receive a score in proportion to their performance compared to the performance of the highest performing supplier.

The output may also be ranked by tiers so that a user may combine groups of performers into common performance rankings. For example, a user may specify in the business logic input data that all suppliers that receive relative scores of 60% or higher are first tier suppliers. Other metrics for determining tiers, such as a measure in the difference in performance between two adjacent suppliers, may also be used to determine tier rankings. In this example, suppliers have been placed into four tiers: first tier 130, second tier 132, third tier 134, and fourth tier 136. It must be understood that other groupings and tier formations are possible, such as only displaying the top “n” suppliers. Lastly, a tabular representation may be used to show the performance results as shown in Table 3.

TABLE 3
Supplier Performance Ranking Table

| Ranking | Supplier | Relative Score | Tier |
|---|---|---|---|
| 1 | Supplier 126 | 100% | 1 |
| 2 | Supplier 138 | 94.82% | 1 |
| . . . | . . . | . . . | . . . |
| 75 | Supplier 128 | 0.00% | 4 |

A second example involves the use of the performance analysis system within a Supplier Relationship Management (SRM) system. In this example three performance measures found in SRM data, namely, Financial Stress Score (FSS), Supplier Evaluation Risk (SER), and Dependency Ratio (ratio of the total amount of purchases to the total amount of sales for a given vendor) are used. From a purchasing manager's perspective, a qualified supplier should have FSS and SER as low as possible, while the dependency ratio should be made as large as it can be, so that the purchasing manager may have better leverage in future negotiations. If, for example, the data includes many missing fields, then the performance system also receives input to determine how to replace the missing data with a data value. The following table shows the settings used for this example.

TABLE 4
Performance measure's settings for the performance example.

| | | Relative Importance | | |
|---|---|---|---|---|
| Performance | Optimization | Lower | Upper | Missing Value |
| Measure | Criterion | Limit | Limit | Replacement |
| FSS | Minimization | 20.0% | 40.0% | Maximum value |
| SER | Minimization | 10.0% | 30.0% | Average |
| Dependency | Maximization | 30.0% | 60.0% | Average |
| ratio | | | | |

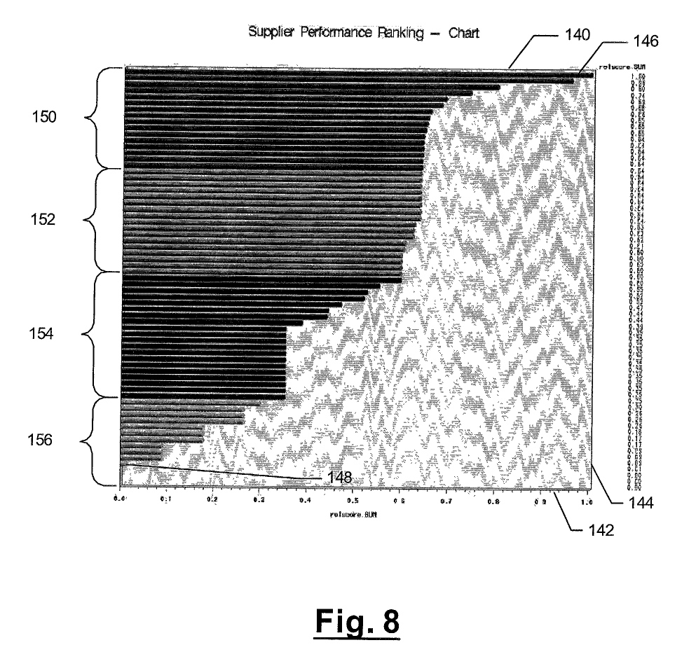

In this example, two of the performance measures are minimized, while one of the performance measures is maximized. Once the relative weighting ranges are input, then each supplier's performance value is optimized by adjusting the weights for each performance measure according to the constraints input by the user and the constraints of the linear program model listed above. The results then can be generated without being restricted to any arbitrary weights and may also be generated by minimizing some performance measures while maximizing others. FIG. 8 depicts the performance analysis results for the second example.

FIG. 8 depicts bar graph 140 with axes 142 and 144. Axis 142 is the ranking score for each supplier in a range from zero to one. Axis 144 contains the suppliers sequentially ordered from the supplier with the highest relative score (i.e., highest performing supplier 146) to the supplier with the lowest relative score (i.e., lowest performing supplier 148). In this example, the suppliers have been placed into four tiers: first tier 150, second tier 152, third tier 154, and fourth tier 156.

As shown by the examples, it will be appreciated that a great number of suppliers may be efficiently and objectively evaluated relative to business logic rules. It will also be appreciated that the description and the supplier examples relate to the preferred embodiments by way of example only. Many variations on the invention will be readily apparent to those knowledgeable in the field, and such variations are within the scope of the invention as described and claimed. For example, the performance ranking model may be optimized by techniques other than linear programming, such as non-linear optimization techniques (e.g., A non-linear technique using non-linear relations in the constraints while modelling the business logic. In this example, the non-linear relations may resemble w₁×w₂≦0.05, where two weights are being multiplied. These types of relations enforce the use of non-linear techniques to solve the resulting math program). As another example of the many variations of the performance analysis system, the system may be used to assemble the best set of different suppliers to be involved in a particular project. A project may need one supplier to manufacture a product while also requiring a service supplier to maintain the product once it is released to the customer. The system employs one set of business logic rules to determine the best supplier for the product, and then employs another set of business logic rules to determine the best service supplier. If the project requires additional suppliers (such as contractors to update the manufacturing software to produce the product), then the system uses a different set of business logic rules to determine which contractor can best update the software. In this way, the performance analysis system may be used to generate in a more objective and automated fashion project plans. The system may also use the selection results for one supplier (e.g., selection of the manufacturing supplier) to adjust the business logic rules in selecting another supplier (e.g., selection of the maintenance supplier). Thus, the business logic rules may be affected by previous supplier selections.

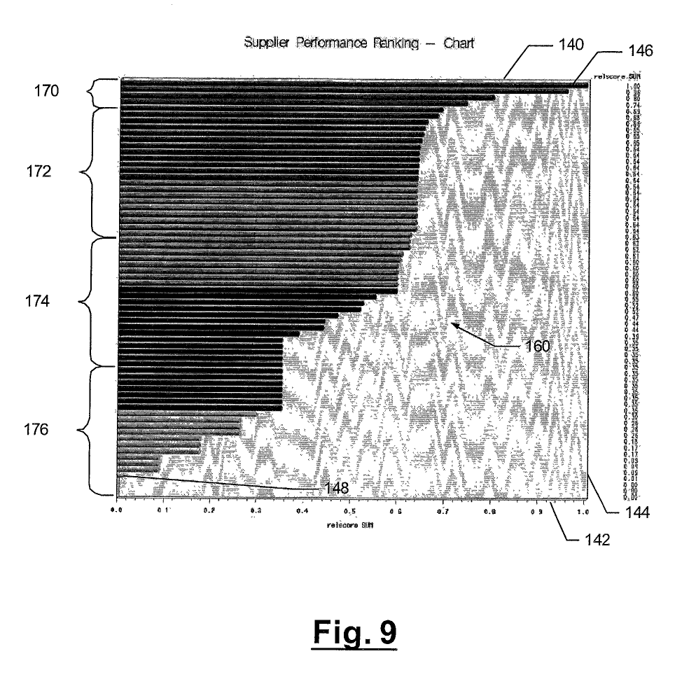

As still another example, the performance analysis system may further analyze the results statistically. FIG. 9 shows at 160 that the contour of the results resembles an “S” shape (note: FIG. 9 contains the same graphical results as in FIG. 8 for the second example). Statistical analysis (through use possibly of a statistical clustering program as available in the industry) of the results' distribution may provide additional information to a user such as due to such a contour shape the upper tiered preferred group of suppliers is much smaller and more exceptional than expected. This may necessitate a different grouping of the suppliers to stress which suppliers have performed exceptionally well. As shown in FIG. 9, tier one 170 may include only the first four exceptionally ranked suppliers, with the remaining suppliers being equally divided among the other three tiers 172, 174, and 176.

It is claimed:

1. A computer-implemented method for assessing performance-related data for a preselected set of performers, comprising the steps of:
receiving data about performance measures of a first performer;
receiving business logic rules related to at least one of the performance measures;
constructing a mathematical optimization program that includes an overall performance rating as an objective function; and
using the mathematical optimization program to optimize the overall performance rating of the first performer by adjusting a set of weights constrained by the business logic rules;
wherein the overall performance rating is used to assess the performance of the first performer.

2. The method of claim 1 further comprising the steps of:
determining absolute weight relationships of the performance measures based upon the business logic rules; and
using the mathematical optimization program to optimize the overall performance rating of the first performer by adjusting the determined absolute weight ranges constrained by the business logic rules.

3. The method of claim 2 further comprising the steps of:
determining relative weight ranges of the performance measures based upon the business logic rules and the absolute weight ranges; and
using the linear program model to optimize the overall performance rating of the first performer by adjusting the determined relative weight relationships constrained by the business logic rules.

4. The method of claim 1 wherein the objective function seeks optimality in the overall performance rating for the first performer constrained by the business logic rules.

5. The method of claim 4 wherein the objective function is solved such that the overall performance rating is maximum.

6. The method of claim 1 further comprising the step of:
normalizing the performance measures data such that the performance measures data have substantially similar ranges.

7. The method of claim 1 further comprising the steps of:
receiving performance measures data for a second performer; and
using the mathematical optimization program to optimize the overall performance rating of the second performer by adjusting a set of weights constrained by the business logic rules, such that the set of weights of the second performer is different from the set of weights for the first performer,
wherein the second performer's overall performance rating is used to assess performance of the second performer with respect to performance of the first performer.

8. The method of claim 7 further comprising the step of:
ranking the overall performance rating of the second performer relative to the overall performance rating of the performer.

9. The method of claim 1 wherein the preselected set of performers includes suppliers that are to be assessed.

10. The method of claim 1 wherein the preselected set of performers includes services that are to be assessed.

11. The method of claim 1 wherein the preselected set of performers includes products that are to be assessed.

12. The method of claim 1 wherein the mathematical optimization program is a non-linear program module.

13. The method of claim 1 wherein the mathematical optimization program is a linear programming module.

14. The method of claim 13 further comprising the step of:
converting the business logic rules into constraints for use by the linear programming module in optimizing the overall performance rating of the first performer,
wherein the overall performance rating is used to assess the performance of the first performer.

15. The method of claim 13 wherein the business logic rules are rules selected from the group consisting of rules that model relative importance between categories contained within the performance measures data, rules that model relative importance between bounded categories contained within the performance measures data, rules that model absolute importance of a category contained within the performance measures data, rules that model absolute importance of a bounded category contained within the performance measures data, and combinations thereof.

16. The method of claim 1 wherein each of the performers is evaluated by the mathematical optimization program in isolation by solving for the best possible combination of the weights that maximizes the overall performance rating of each performer.

17. The method of claim 1 wherein the performance measures data interrelates a performer with at least two performance measurements.

18. The method of claim 1 further comprising the steps of:
receiving performance measures data for a plurality of performers;
using the mathematical optimization program to optimize the overall performance rating for each of the performers; and
forming tiers by grouping the performers based upon their respective overall performance ratings.

19. The method of claim 18 further comprising the steps of:
providing the overall performance ratings of the performers to a statistical analysis program means; and
forming non-uniform tiers by grouping the performers based upon performance distribution analysis performed by the statistical analysis program means.

20. A computer-implemented apparatus for analyzing performance measures data for a preselected set of performers, comprising:
a constraint engine that constructs constraints based upon business logic rules, said business logic rules being related to at least one measurement contained within the performance measures data;
a mathematical optimization program connected to the constraint engine that includes an overall performance rating as an objective function;
said mathematical optimization program using the performance measures data to optimize the overall performance rating of the performers by adjusting a set of weights constrained by the business logic constraints,
wherein the overall performance rating is used to assess the performance of the performers.

21. The apparatus of claim 20 wherein the objective function seeks optimality in the overall performance rating for the performers constrained by the business logic constraints.

22. The apparatus of claim 21 wherein the objective function is solved such that the overall performance rating is maximum.

23. The apparatus of claim 20 wherein the preselected set of performers includes suppliers that are to be assessed.

24. The apparatus of claim 20 wherein the preselected set of performers includes services that are to be assessed.

25. The apparatus of claim 20 wherein the preselected set of performers includes products that are to be assessed.

26. The apparatus of claim 20 wherein the mathematical optimization program is a non-linear program module.

27. The apparatus of claim 20 wherein the mathematical optimization program is a linear programming module.

28. The apparatus of claim 27 wherein the business logic rules are converted into the constraints for use by the linear programming module in optimizing the overall performance ratings of the performers, wherein the overall performance ratings are used to assess the performances of the performers.

29. The apparatus of claim 27 wherein the business logic rules are rules selected from the group consisting of rules that model relative importance between categories contained within the performance measures data, rules that model relative importance between bounded categories contained within the performance measures data, rules that model absolute importance of a category contained within the performance measures data, rules that model absolute importance of a bounded category contained within the performance measures data, and combinations thereof.

30. The apparatus of claim 20 wherein each of the performers is evaluated by the mathematical optimization program in isolation by solving for the best possible combination of the weights that maximizes the overall performance rating of each performer.

31. The apparatus of claim 20 wherein tiers are formed by grouping the performers based upon their respective overall performance ratings.

32. The apparatus of claim 31 further comprising:
a statistical analysis program means to analyze distribution of the overall performance ratings of the performers, wherein non-uniform tiers are formed by grouping the performers based upon the performance distribution analysis performed by the statistical analysis program means.
